(19) United States
(12) Patent Application Publication
(10) Pub. No.: US 2002/0066345 A1
(43) Pub. Date: Jun. 6, 2002

(54) Waterjet edge cut taper controlling method

(76) Inventors: John D. Shepherd, Manhattan, IL (US); John K. Shepherd, Lockport, IL (US)

Correspondence Address: PHILIP M. KOLEHMAINEN, 910 W VAN BUREN #302, CHICAGO, IL, 60607, US

(21) Appl. No.: 09/730,798

(22) Filed: Dec. 6, 2000

(51) Int. Cl. B26F 3/00; B26D 5/02

(52) U.S. Cl. 83/53; 83/34; 83/177; 83/581; 83/699.51; 83/829

(57) ABSTRACT

A waterjet head is tilted relative to vertical in order that the edge of a cut made by the head when severing a part from a workpiece is perpendicular to the workpiece surface, or is oriented at another desired inclination. As the waterjet head is moved along a cutting path over the workpiece, the plane in which the waterjet head is tilted is maintained at a constant bevel control angle relative to the direction of movement of the waterjet head. The waterjet head together with a tilt control assembly is carried by a support that is moved by a CNC controlled three axis drive system. The tilt control assembly includes provision for adjustably tilting the waterjet head and for rotating the waterjet head to maintain the bevel control angle as the direction of waterjet head movement changes.

### FIELD OF THE INVENTION

The present invention relates to controlling, reducing or eliminating the tapered edge that results when a workpiece is cut with an ultra high pressure waterjet head.

### DESCRIPTION OF THE PRIOR ART

Waterjet systems can be used to cut flat planar workpieces. A typical waterjet system includes a waterjet head that is supplied with liquid at an ultra high pressure (UHP), for example 10,000 to 60,000 pounds per square inch (psi). The UHP liquid is discharged in an axial direction from the head in a high velocity stream against the workpiece. The liquid stream is used to cut through materials such as wood, paper and foam. An abrasive particulate material can be added to the stream, and the liquid/abrasive stream can be used to cut through composites, metals and other dense materials. The cutting stream typically is concentrated in a small area, for example, for example as small as 0.05 inch diameter and has a high flow rate of perhaps one to three gallons per minute (gpm). With commonly available equipment, the waterjet head and the cutting stream are maintained perpendicular to the top surface of the workpiece and are moved by a computer numerically controlled (CNC) system in order to cut through the workpiece along a cut line.

Although waterjet cutting systems have many advantages, an unfortunate result of making a cut with a waterjet cutting stream is the problem of taper of the cut edge. In most instances it would be desirable for the finished edge to have no taper and to be in a plane perpendicular to the workpiece top surface. However, the waterjet cutting stream typically produces an edge that is inclined or tapered. Most commonly, the cutting stream removes more material at the top than at the bottom of the cut, and in this case the resulting cut edge has what can be termed a positive taper. The amount of the taper is dependent on many variables including the speed at which the waterjet head is moved along the workpiece surface. At very slow speeds a relatively taper-free or a negatively tapered edge can be formed.

A prior art waterjet cutting system designated as a whole as 10 is shown in FIG. 1. The system 10 is used to form a cut 12 in a workpiece 14, and includes a waterjet head assembly 16. The waterjet head 16 includes a valve body 18 operated to open or closed positions by an actuator 20 controlled remotely by the presence or absence of pressurized air supplied to the actuator 20 through an air control conduit 22. Ultra high pressure (UHP) liquid is supplied to the waterjet head 16 from a suitable UHP pump system through a UHP liquid supply conduit 23 normally formed of stainless steel and having sufficient flexibility to permit movement of the waterjet head 16 around the surface of the workpiece 14.

A valve nut 24 attaches a tube 26 to the bottom of the valve body 18. When the valve in the valve body 18 is opened by the application of pressurized air within the actuator 20, UHP liquid flows downward through the valve body 18 and the tube 26 to an outlet nozzle assembly 28 including a mixing chamber housing 30 and a nozzle 32. The nozzle 32 is aligned with the longitudinal axis of the waterjet head 16, and includes an axial discharge passage through which a concentrated UHP liquid stream is discharged at high pressure and high velocity.

For many applications, fine particles of an abrasive material such as garnet are added to the liquid stream. The mixing chamber member 30 receives particulate abrasive through a flexible rubber or neoprene abrasive supply line 34. When UHP liquid flows through the mixing chamber member 30, abrasive material is entrained in the liquid stream and a liquid/abrasive stream having increased cutting capability is discharged from the nozzle 32.

The waterjet head 16 is supported, typically with its axis vertical and perpendicular to the top surface 38 of the workpiece 14, by a clamp 36 or similar fixture. The clamp 36 is carried by a support arm 40 extending from a clamp plate 42 attached to a front plate 44 of a support member or lift 46. The lift 46 is moved in three orthogonal directions by a three axis X-Y-Z drive 48. Typically the drive 48 can move the waterjet head 16 in an X direction from side to side over the workpiece 14 and, separately or simultaneously, in a Y direction forward and rearward over the workpiece 14. The drive 48 can also move the head 16 in a Z direction, vertically with respect to the workpiece. A computer numerical control (CNC) system 50 controls the drive 48 to perform a cutting operation upon the workpiece 14. The head is moved in the Z direction to place the outlet of the nozzle 32 near the top workpiece surface 38. Then the control system moves the head 16 in the X and/or Y directions to form the cut 12. Typically the control system 50 is programmed to cut the workpiece in selected straight and/or curved lines and/or corners to fabricate finished parts having a desired shape.

Prior art waterjet systems of the type seen in FIG. 1 are commercially available from sources including EASB Cutting Systems, 411 Ebenezer Road, Florence, S.C. 29501-0504. A further description of the prior art system 10 can be found at the title pages and pages 2-4, 2-5, 2-7, 2-8, 2-12, 4-29, 4-30 and 2-24 through 6-26 of ESAB Cutting Systems manual No. F14-135 dated May, 1999, filed herewith and incorporated herein by reference. A further description of a prior art waterjet head can also be found in U.S. Pat. No. 6,126,524 incorporated herein by reference.

When the cut 12 is formed in the workpiece 14 by the vertically disposed head 16, the sides of the cut 12 are defined by inclined, sloped walls 12A and 12B. These sloped walls form a tapered cut 12. The slope of the sides 12A and 12B of the tapered cut 12 can be as large as a several degrees. This taper is undesirable, and in most operations a side wall of the finished part that is perpendicular to the top surface 38 would be preferred. In some operations, a taper different from that of sides 12A and 12B would be preferred, for example to provide a beveled edge.

It would be desirable to control the taper of the cut edge so that taper could be reduced or eliminated or, alternatively, so that a controlled beveled edge of a desired angle could be produced. It has been recognized that positive taper can be reduced by slowing the cutting speed of the waterjet head. However this adds to manufacturing time and cost. In addition, expensive five axis waterjet machines are available. In a five axis machine, an expensive and complex drive system permits the waterjet head to be tilted and pivoted by the CNC system in order to reduce taper or bevel the cut edge. The high cost of this type of equipment is a deterrent to its use. Few general purpose job shops can afford expensive five axis systems. It would therefore be desirable to provide a method of controlling edge taper using standard waterjet apparatus.

### SUMMARY OF THE INVENTION

A principal object of the present invention is to provide an improved method for controlling the bevel of a cut made by a waterjet head when cutting through a workpiece. Other objects are to provide a bevel control method that does not require an expensive five axis drive system and that can be easily adapted to widely available three axis systems; to provide a method that maintains a constant edge inclination as the waterjet head changes direction in a cutting path over the workpiece; to provide a method that can be carried out at high cutting speeds; and to provide a method that overcomes disadvantages of known approaches used to attempt to avoid undesired edge bevels in waterjet cutting operations.

In brief, in accordance with the invention there is provided a method for controlling the taper of an edge made by cutting a workpiece with a waterjet head. The method includes supporting the waterjet head and a head drive system on a support. The waterjet head is tilted relative to the support so that the longitudinal axis of the waterjet head is at a tilt angle relative to a vertical line. The vertical line and the waterjet head axis define a common tilt plane. The support is moved with a primary drive system along a predetermined line over a surface of the workpiece. UHP liquid is emitted from the waterjet head to cut through the workpiece and make an edge along the predetermined line. The waterjet head is rotated around the vertical line using the head drive system so that the tilt plane is at a bevel control angle relative to the direction of movement of the waterjet head along the predetermined line.

### BRIEF DESCRIPTION OF THE DRAWING

The present invention together with the above and other objects and advantages may best be understood from the following detailed description of the preferred embodiments of the invention illustrated in the drawings, wherein:

FIG. 1 is a partly schematic, side elevational view of a prior art waterjet cutting system also showing in cross section a cut made by the system in a workpiece;

FIG. 2 is a partly schematic, side elevational view of a waterjet cutting system of the present invention also showing in cross section a cut in a workpiece made by performing the method of the present invention;

FIG. 3 is an enlarged side view, partly in axial section, of the waterjet head and tilt control system of the waterjet cutting system of FIG. 2;

FIG. 4 is an enlarged top view of the drive pulley and self aligning bearing of the tilt control system of FIG. 3;

FIG. 5 is an axial sectional view of the drive pulley of the tilt control system of FIG. 3;

FIG. 6 is a side view, with portions seen in cross section, of an alternative form of a waterjet head tilt control system for performing the method of the present invention;

FIG. 7 is a fragmentary side view of the follower wheel assembly of the tilt control system taken from the line 7-7 of FIG. 6; and

FIG. 8 is a schematic view illustrating an example of cutting a workpiece in accordance with the present invention.

### DETAILED DESCRIPTION OF THE PREFERRED EMBODIMENTS

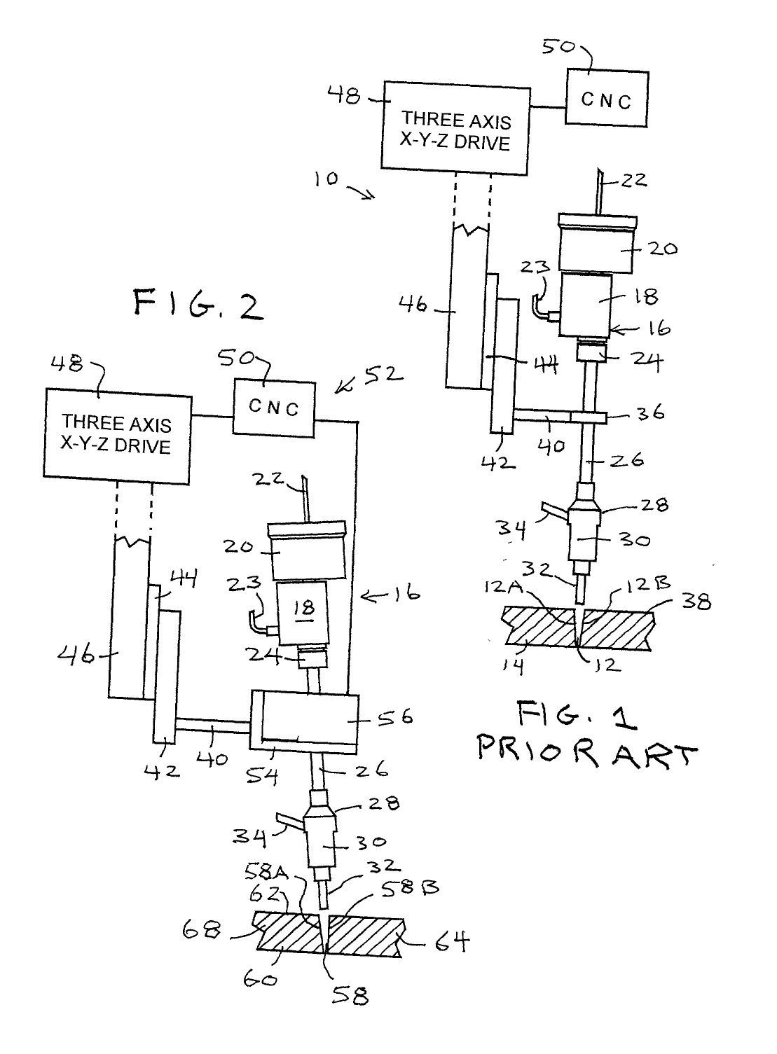

Having reference now to the drawings, FIG. 2 shows a waterjet cutting system in accordance with the present invention, generally designated as 52. An advantage of the invention is that it can incorporate many of the components of a standard, prior art system such as that seen in FIG. 1, and therefore is relatively low in cost. In FIG. 2 and the other figures of the drawings, the same reference characters are used for components of the system that are in common with the system of FIG. 1, and the description of these common components is not repeated except where helpful to an understanding of the invention.

In the system 52, a support 54 carries a tilt control assembly 56 that in turn supports the waterjet head 16. As described below, the tilt control assembly 56 supports the waterjet head 16 for tilting motion of its axis relative to a vertical line, and for rotation of the waterjet head around the vertical line. These motions of the waterjet head 16 are achieved separate and apart from the primary X-Y-Z drive 48, and do not require a more complex and expensive five axis drive system. The X-Y-Z drive 48 moves the support 54 in three orthogonal directions while the separate and mechanically independent tilt control assembly 56 tilts and rotates the waterjet head 16.

As seen in FIG. 2, the waterjet cutting system 52 is used to make a cut 58 in a workpiece 60 having a top surface 62. In accordance with the invention, the tilt control assembly is used to control the taper of the finished edge resulting from the cut 58. The cut 58 is defined on one side by an edge 58A and on the other side by an opposed edge 58B. In FIG. 2, the portion of the workpiece 60 including the edge 58B is a finished part 64 severed from the workpiece 60 by the waterjet cutting operation. The tilt control assembly 56 maintains the waterjet head 16 tilted at a predetermined angle relative to a vertical line so that, in the arrangement of FIG. 2, the edge 58B is generally perpendicular to the top surface 62. In the example of FIG. 2, the edge 58B is generally perpendicular to the top workpiece surface 62.

The method of the invention is schematically seen in FIG. 8. The workpiece 60 is cut along a line 66 seen on the top surface 62. The line 66 includes a first segment 66A extending in what can be termed a plus X direction, a second segment 66B extending in a Y direction and a segment 66C extending in a negative X direction. The X-Y-Z drive 48 moves the support 54, the tilt control assembly 56 and the waterjet head 16 over the surface 62 to form the cut 58 through the workpiece along the line 66. The cut 58 along the line 66 severs the finished part 64 from the workpiece 60, leaving a scrap section 68 of the workpiece 60.

The tilt angle of the waterjet head 16 relative to a vertical line is selected so that the generally perpendicular cut edge 58B is achieved on the finished part side of the cut 58. The axis of the tilted waterjet head 16 and the vertical line are in a common tilt plane. The tilt control assembly rotates the tilted waterjet head 16 to achieve the perpendicular edge 58B along the entire length of the cut 58 extending along the line 66. The tilt control assembly maintains the tilt plane at a constant bevel control angle relative to the direction of travel of the waterjet head 16.

More specifically, at one point in the line segment 66A, a vertical line 70A is drawn for reference. The axis of the waterjet head 16 when it intersects the line 70A is represented by a line 72A. The lines 70A and 72A form a tilt angle 74, and lie in a common tilt plane. Along the line segment 66A, this common tilt plane lies in the Y direction, perpendicular to the line segment 66A and to the direction of travel of the waterjet head 16 along the line segment 66A. In this example, the bevel control angle is ninety degrees.

When the moving waterjet head 16 completes cut 58 along line segment 66A and reaches the corner at line segment 66 B, the tilt control assembly 56 rotates the waterjet head 16 in order to place the tilt plane in the X direction and to maintain the tilt plane at the ninety degree bevel control angle to the line segment 66B and to the direction of travel of the waterjet head 16. At one point in the line segment 66B, a vertical line 70B is drawn for reference. The axis of the waterjet head 16 when it intersects the line 70B is represented by a line 72B. The lines 70B and 72B continue to form the tilt angle 74, and continue to lie in the common tilt plane. At the ninety degree corner where line segment 66A meets line segment 66B, the waterjet head 16 is rotated ninety degrees to maintain the constant ninety degree bevel control angle between the tilt plane and the direction of movement of the waterjet head 16.

At the ninety degree corner where the waterjet head 16 moves from line segment 66B to line segment 66C, the tilt control assembly 56 again rotates the waterjet head 16 ninety degrees to keep the tilt plane at the constant bevel control angle, perpendicular to the direction of travel of the waterjet head 16. At one point in the line segment 66C, a vertical line 70C is drawn for reference. The axis of the waterjet head 16 when it intersects the line 70C is represented by a line 72C. The lines 70C and 72C continue to form the tilt angle 74, and continue to lie in the common tilt plane. The bevel control angle of ninety degrees relative to the direction of travel is maintained. The line 72C is inclined oppositely to the line 72A because the direction of travel of the waterjet head 16 along line segment 66C is opposite to the direction of travel along the line segment 66A.

The bevel control angle can be an angle different from ninety degrees if desired. The ninety degree angle is preferred because it minimized the size of the tilt angle 74 required to obtain the perpendicular finished edge 58B. The size of the tilt angle needed to produce a perpendicular edge 58B depends on the material and thickness of the workpiece, the speed of movement of the waterjet head 16 and other factors. The tilt angle for a particular job can be determined by experimentation with trial runs or by past experience. The line 66 seen in FIG. 8 includes straight line segments and sharp ninety degree corners. However, the invention is applicable to any cutting line including curved line segments, radiused corners and any other shapes. Regardless of the configuration of the path, the tilt control assembly operates to maintain a constant bevel control angle. The tilt angle is chosen to achieve the edge orientation that is desired. FIG. 2 illustrates the tilt angle selected to achieve an edge 58B that is perpendicular to the top surface 62. A smaller angle or a tilt in the opposite direction may be selected to achieve a positive beveled edge. A larger angle may be selected to achieve a reverse or negative beveled edge. The bevel control angle can be varied along the path of cutting if a uniform edge is desired, for example, beveled on one portion of the finished part and perpendicular on another portion.

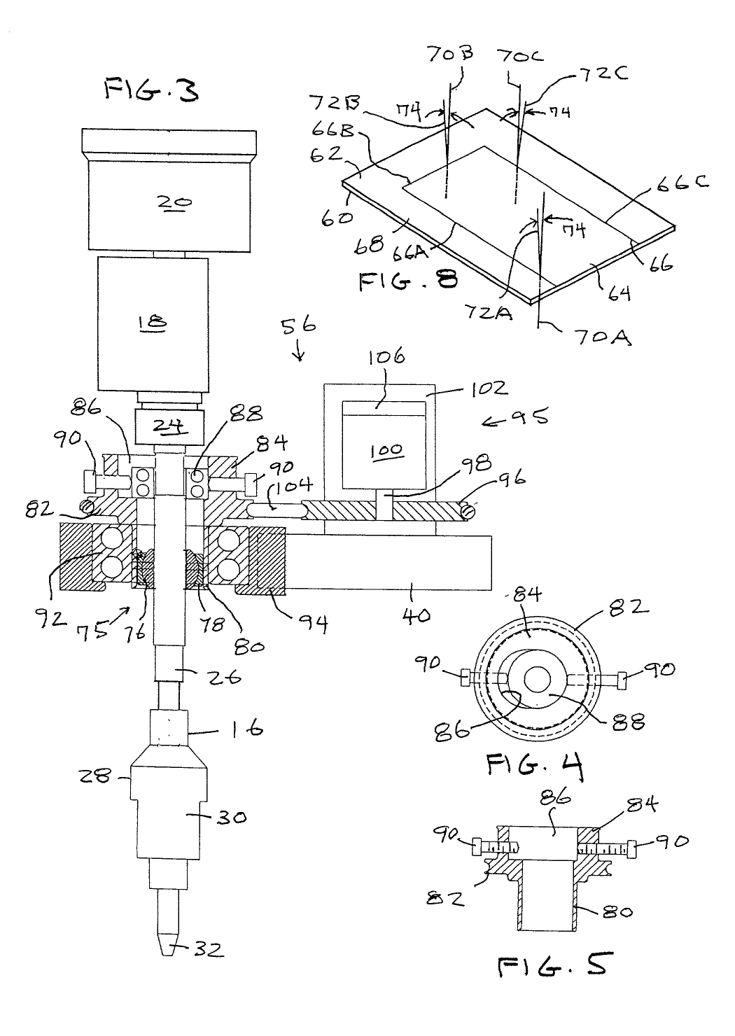

Referring now to FIGS. 3-5, the tilt control assembly 56 of the waterjet cutting system 52 is shown. The waterjet head 16 is tilted by pivoting about a pivot point established by a spherical ball joint bearing assembly 75 including an inner bearing 76 secured to the tube member 26 and an outer bearing 78 carried in a collar portion 80 of a drive pulley 82. An upper body portion 84 of the pulley 82 includes an eccentric slot 86 slideably receiving a self aligning roller bearing assembly 88, for example bearing model No. 2207 available from McMaster-Carr Supply Company located at 600 County Line Road, Elmhurst, Ill. 60126 and at other locations. The bearing assembly 88 receives the tube member 26 at a point spaced above the ball joint bearing assembly 75. The assembly 88 permits axial misalignment of a number of degrees between the vertical bearing assembly axis and the tube member 26. If desired, a second ball joint bearing assembly like the assembly 75 could be used in place of the assembly 88.

In order to tilt the longitudinal axis of the waterjet head 16, the bearing assembly 88 is moved laterally within the slot 88 away from the central, vertical position seen in FIG. 3 to an off center position selected to obtain the desired tilt angle. A pair of opposed screws 90 are used to hold the bearing assembly 88 at the desired position in the slot 86. As the bearing assembly 88 is moved away from the central or vertical position seen in FIG. 3, the waterjet head 16 pivots about the bearing assembly 75 and the tilt angle increases.

The collar portion 80 of the pulley 82 is journaled for rotation in a bearing assembly 92 secured in a mounting block 94 attached to the support arm 40. The arm 40 and block 94 form a support for the tilt control assembly 54, and this support is moved in X, Y and Z directions by the primary three axis drive 48. The bearing assemblies 88 and 92 permit the tilted waterjet head 16 to rotate around a vertical line coinciding with the longitudinal axis of the waterjet head 16 when it is in a vertical position. This vertical line at the center of rotation extends through the center of the ball joint bearing assembly 75, and, for example, corresponds to the lines 70A, B and C seen in FIG. 8. The tilt angle is defined by the vertical line and the axis of the tilted waterjet head 16, and these two lines are in a common plane, termed the tilt plane in the present description.

A drive system 95 for rotating the waterjet head 16 includes the drive pulley 82 and an aligned driver pulley 96 keyed to a drive shaft 98 of a drive motor 100. Motor 100 is carried by a plate 102 that is fixed to the block 94 and/or to the support arm 40 to form part of the support for the tilt control assembly 56. The motor 100 may be a DC stepper motor actuated under the control of the CNC system 50 (FIG. 2). A drive belt 104 rotates the pulley 82 and the waterjet head 16 in response to rotation of the motor shaft 98 and driver pulley 96. The motor 100 is provided with a sensor 106, such as an encoder, that senses and feeds back to the CNC system a position signal that permits the CNC system to rotate the waterjet head 16 to place the tilt plane at any desired orientation. The CNC system controls the drive 48 to move the waterjet head 16 along a cutting path, such as for example the line 66 of FIG. 8. Therefore the CNC system in accordance with the invention also maintains the drive plane at the desired bevel control angle, such as ninety degrees, to the direction of movement of the waterjet head 16.

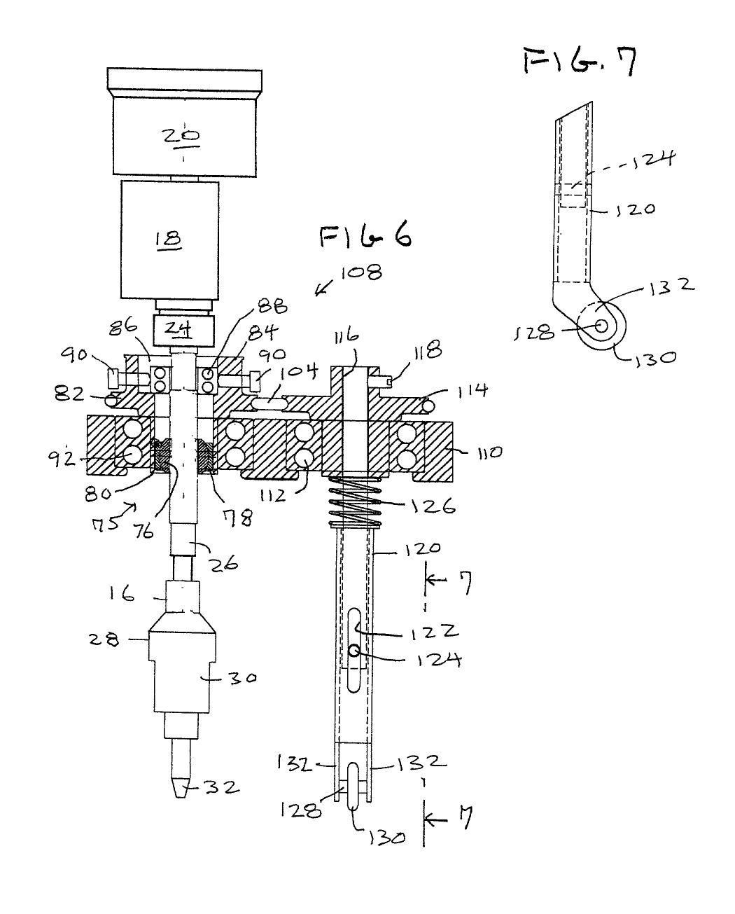

Another tilt control assembly generally designated as 108 is seen in FIGS. 6 and 7. Some components of the tilt control assembly 108 are the same as those of the tilt control assembly 56 and are provided with the same reference characters. Bearing assembly 92 of the tilt control assembly 108 is supported by a mounting block 110 that also supports another similar bearing assembly 112 rotatably supporting a driver pulley 114 having the same diameter as the drive pulley 82. Drive belt 104 produces simultaneous rotation of the pulleys 114 and 82. The block 110 is secured to the mounting arm 40 (FIG. 2).

An inner shaft 116 is secured by a set screw 118 in a central axial passage extending through the driver pulley 114. An outer shaft 120 is slideably telescoped over the inner shaft 116, and a slot 122 and pin 124 prevent relative rotation of the shafts 116 and 120. The outer shaft 120 is urged downward by a compressed spring 126. The lower end of the shaft 120 carries an axle 128 with a follower wheel 130 that rolls along the top surface of the workpiece to the side of the waterjet head 16 when the waterjet head 16 moves along a cutting path on the workpiece. A pair of inclined legs 132 (FIG. 7) offset the point of contact of the wheel 130 away from the axis of the shafts 116 and 120. As a result the wheel 130 follows the path of travel of the waterjet head 16 along the workpiece. When the waterjet head 16 is moved, the plane of the wheel 130 is parallel to the direction of motion of the waterjet head 16.

The drive belt is related to the pulleys 82 and 114 so that the plane of the wheel 130 and the direction of travel of the waterjet head 16 are at the preferred bevel control angle, for example ninety degrees, to the tilt plane. The wheel 130 serves to detect the direction of movement of the waterjet head 16. When the direction of movement changes, the follower wheel 130 causes the shafts 120 and 116 and the driver pulley 114 to rotate the same amount. Rotation of the pulley 114 is coupled through the drive belt 104 to cause identical rotation of the drive pulley 82 and of the tilt plane. The bevel control angle of the tilt plane relative to the direction of movement is maintained constant.

While the present invention has been described with reference to the details of the embodiments of the invention shown in the drawings, these details are not intended to limit the scope of the invention as claimed in the appended claims.

What is claimed is:

1. A method for controlling the taper of an edge made by cutting a workpiece with a waterjet head, said method comprising:
supporting the waterjet head and a head drive system on a support;
tilting the waterjet head relative to the support so that the longitudinal axis of the waterjet head is at a tilt angle relative to a vertical line, the vertical line and the waterjet head axis defining a common tilt plane;
moving the support with a primary drive system along a predetermined line over a surface of the workpiece;
discharging UHP liquid from the waterjet head to cut through the workpiece and make an edge along the predetermined line; and
rotating the waterjet head around the vertical line using the head drive system so that the tilt plane is at a bevel control angle relative to the direction of movement of the waterjet head along the predetermined line.

2. A method as claimed in claim 1, said moving step comprising driving said support with a three axis X-Y-Z drive.

3. A method as claimed in claim 1 wherein said rotating step includes maintaining the tilt plane at a constant bevel control angle to the direction of movement.

4. A method as claimed in claim 3 wherein the constant bevel control angle is about ninety degrees.

5. A method as claimed in claim 3 further comprising
determining in a trial run the taper of the edge that would result from cutting the workpiece with the waterjet head having a vertical axis;
said tilting step including selecting the tilt angle and the bevel control angle to reduce the determined bevel.

6. A method as claimed in claim 4 further comprising
determining in a trial run the taper of the edge that would result from cutting the workpiece with the waterjet head having a vertical axis;
said tilting step including selecting the tilt angle to reduce the determined bevel.

7. A method as claimed in claim 1 further comprising
detecting the direction of motion of the waterjet head along the predetermined line and
said rotating step including controlling the head drive system in accordance with said detecting step to maintain the bevel control angle constant.

8. A method as claimed in claim 1 further comprising
sensing the position of a motor in the head drive system, and
said rotating step including controlling the head drive system in accordance with said sensing step to maintain the bevel control angle constant.

9. Waterjet apparatus for cutting through a workpiece and making a workpiece edge, said apparatus comprising
a support;
a waterjet head having a longitudinal axis;
a mounting system securing said waterjet head on said support for tilting motion relative to a vertical line and for rotation around said vertical line;
a head drive system for rotating said waterjet head around said vertical line;
a drive separate from said head drive system for moving the support along a line over a surface of the workpiece;
a detector for determining the direction of movement of the waterjet head; and
the detector being connected to the head drive system for maintaining the waterjet head axis tilted at a constant angle relative to the direction of movement.

10. The waterjet apparatus of claim 9, said detector comprising a workpiece engaging follower.
